(19) United States
(12) Patent Application Publication
(10) Pub. No.: US 2026/0099076 A1
(43) Pub. Date: Apr. 9, 2026

(54) ELECTROCHROMIC WINDOW FRAMING SYSTEMS WITH ACCESSIBLE WIRING AND COMPONENTS

(71) Applicant: View Operating Corporation, San Jose, CA (US)

(72) Inventor: Robert Michael Martinson, Milpitas, CA (US)

(21) Appl. No.: 19/189,887

(22) Filed: Apr. 25, 2025

Related U.S. Application Data
(63) Continuation of application No. PCT/US23/36098, filed on Oct. 27, 2023.
(60) Provisional application No. 63/419,794, filed on Oct. 27, 2022.
(60) Provisional application No. 63/419,987, filed on Oct. 27, 2022.

(51) Int. Cl. G02F 1/163; E06B 3/16; E06B 3/66; E06B 3/67

(52) U.S. Cl. CPC G02F 1/163; E06B 3/6621; E06B 3/6722; E06B 3/16

(57) ABSTRACT

Assemblies having first and second insulated glass units with one or more IGU cables and frame having an intermediate horizontal member interposed between IGUs, wherein the frame is configured to pass the one or more IGU cables into the intermediate horizontal member.

### CROSS REFERENCES TO RELATED APPLICATIONS

This application is a continuation of International Application No. PCT/US2023/036098 designating the United States, filed on Oct. 27, 2023, which claims benefit of and priority to U.S. Provisional Application 63/419,794, titled “ELECTROCHROMIC WINDOW FRAMING SYSTEMS WITH ACCESSIBLE WIRING AND COMPONENTS,” and filed on Oct. 27, 2022 and to U.S. Provisional Application 63/419,987, titled “ELECTROCHROMIC WINDOW FRAMING SYSTEMS WITH ACCESSIBLE WIRING AND COMPONENTS,” and filed on Oct. 27, 2022; each of these applications is hereby incorporated by reference in its entirety and for all purposes.

### BACKGROUND

Electrochromism is a phenomenon in which a material exhibits a reversible electrochemically-mediated change in an optical property when placed in a different electronic state, typically by being subjected to a voltage change. The optical property is typically one or more of color, transmittance, absorbance, and reflectance. One well known electrochromic material is tungsten oxide (WO3). Tungsten oxide is a cathodic electrochromic material in which a coloration transition, transparent to blue, occurs by electrochemical reduction.

Electrochromic materials may be incorporated into, for example, windows for residential, commercial, and other uses. The color, transmittance, absorbance, and/or reflectance of such windows may be changed by changing a feature of the electrochromic material, that is, electrochromic windows are windows that can be darkened or lightened electronically. A small voltage applied to an electrochromic device of the window will cause them to darken; reversing the voltage causes them to lighten. This capability allows control of the amount of light that passes through the windows, and presents an opportunity for electrochromic windows to be used as energy-saving devices.

While electrochromism was discovered in the 1960s, electrochromic devices, and particularly electrochromic windows, still suffer various problems and have not begun to realize their full commercial potential despite many recent advancements in electrochromic technology, apparatus, software, and related methods of making and/or using electrochromic devices.

### SUMMARY

Certain embodiments pertain to assemblies having a plurality of insulated glass units (IGUs) and a frame having one or more intermediate horizontal members, each intermediate horizontal member interposed between two of the IGUs. At least one of the IGUs has an IGU cable and the frame is configured to pass the IGU cable into the one or more intermediate horizontal members.

Some embodiments pertain to assemblies having a first IGU, a second IGU, a frame having an intermediate horizontal member and a first vertical member, and one or more IGU cables in electrical communication with the first and second IGUs. The intermediate horizontal member is interposed between the first and second IGUs. The frame is configured to pass the one or more IGU cables from the first and second IGUs into the intermediate horizontal member and through the first vertical member. In some cases, the frame is configured to pass the one or more IGU cables from the first vertical member to outside the assembly. In some cases, the assembly includes a controller within the frame. In some cases, the assembly includes one or more additional IGUs and their respective cable(s). In some cases, the intermediate horizontal member includes a seat element upon which one of the IGUs is seated.

Some embodiments pertain to assemblies having a smart window controller (SWC) comprising a memory configured to store information about an insulated glass unit. The assemblies also include an SWC cable in electrical communication with the smart window controller and an IGU cable in electrical communication with an insulated glass unit and with the SWC cable. The assemblies also include a third cable in electrical communication with the SWC and a second controller.

Some embodiments pertain to assemblies having first and second insulated glass units (IGUs) and a frame comprising an intermediate horizontal member and a first vertical member, wherein the intermediate horizontal member is interposed between the first and second IGUs. The assemblies also include a first IGU cable in electrical communication with the first IGU and a second IGU cable in electrical communication with the second IGU. In addition, the assemblies include a first smart window controller within a body of the intermediate horizontal member, the smart window controller configured to store information about the first IGU, wherein the frame is configured to pass the first IGU cable from the first IGU into the intermediate horizontal member to connect to the first smart window controller.

Some embodiments pertain to methods of fabricating an assembly comprising first and second insulated glass units and a frame, the frame comprising a first vertical member and an intermediate horizontal member interposed between the first and second insulated glass units. The method includes routing a first IGU cable from the first insulated glass unit into the intermediate horizontal member and routing the first IGU cable through a hole in the vertical member and passing the first IGU cable through the vertical member.

These and other features and embodiments will be described in more detail with reference to the drawings.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

FIG. 1A is a drawing depicting an off-angle view of an assembly having two insulated glass units with one or more cables routed through structural members, according to embodiments.

FIG. 1B is a drawing depicting an off-angle view of an assembly having four insulated glass units with one or more cables routed through structural members, according to embodiments.

FIG. 2 is a drawing depicting an off-angle view of an assembly with two insulated glass units, two vertical structural members, and three horizontal structural members, according to embodiments.

FIG. 3 is a drawing depicting a cross-sectional side view of a portion of an assembly in a stick build configuration with two insulated glass units, a pressure plate, and a horizontal member having a seat for an IGU, according to embodiments.

FIG. 4 is a drawing depicting a cross-sectional side view of a portion of an assembly in a stick build configuration with two insulated glass units, a pressure plate, and a horizontal member configured to connect with a structural member having a seat for an IGU, according to embodiments.

FIG. 5 is a drawing depicting a cross-sectional side view of the horizontal member in FIG. 4 with the removable cover exploded away from the horizontal member.

FIG. 6 is a drawing depicting an assembly having two insulated glass units with cable retention features including clips, according to embodiments.

FIG. 7A is a drawing depicting a cross-sectional side view of a portion of a unitized assembly in a structural silicone configuration, according to embodiments.

FIG. 7B is a drawing depicting a cross-sectional side view of a portion of a unitized assembly in a structural silicone configuration, according to embodiments.

FIG. 8 is a drawing depicting an off-angle view of an example of components of an assembly, according to an implementation.

FIG. 9 is a drawing depicting an off-angle view of another example of components of an assembly, according to an implementation.

FIG. 10 is a drawing depicting an off-angle view of an example of components of an assembly with two insulated glass units and a controller positioned inside an intermediate horizontal structural member, according to an implementation.

FIG. 11 is a drawing depicting an off-angle view of an example of components of an assembly with two insulated glass units and a controller positioned inside a horizontal structural member, according to an implementation.

FIG. 12 is a drawing depicting an off-angle view of an example of components of an assembly with two insulated glass units and a controller positioned outside of the envelope of the assembly, according to an implementation.

FIG. 13 is a drawing depicting an off-angle view of a portion of the assembly in FIG. 12.

FIG. 14 is a drawing depicting an off-angle view of an example of components of an assembly with four insulated glass units, according to various embodiments.

FIG. 15 is a schematic drawing depicting an assembly including a smart window controller (SWC), an IGU, and a controller, according to embodiments.

FIG. 16A is a schematic drawing depicting an example of a wire and cable configuration of an assembly including a smart window controller, according to embodiments.

FIG. 16B depicts a plan view of components of the assembly in FIG. 16A.

FIG. 17 depicts a flowchart including operations of a manufacturing technique or method of fabrication of an assembly having two or more IGUs, according to various implementations.

The figures and components therein may not be drawn to scale.

### DETAILED DESCRIPTION

Different aspects are described below with reference to the accompanying drawings. The features illustrated in the drawings may not be to scale. In the following description, numerous specific details are set forth in order to provide a thorough understanding of the presented implementations. The disclosed implementations may be practiced without one or more of these specific details. In other instances, well-known operations have not been described in detail to avoid unnecessarily obscuring the disclosed implementations. While the disclosed implementations will be described in conjunction with specific examples, it will be understood that it is not intended to limit the disclosed implementations.

Numeric ranges are inclusive of the numbers defining the range. It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The term “tintable window” refers to a window (e.g., an architectural window) comprising one or more optically switchable devices (e.g., electrochromic devices). An example of a tintable window is an electrochromic window having one or more tintable devices. In examples involving commissioning of tintable windows, a tintable window is sometimes referred to as an “insulated glass unit” or “IGU.”

The headings provided herein are not intended to limit the disclosure.

Unless defined otherwise herein, all technical and scientific terms used herein have the same meaning as commonly understood by one of ordinary skill in the art. Various scientific dictionaries that include the terms included herein are well known and available to those in the art. Although any methods and materials similar or equivalent to those described herein find use in the practice or testing of the embodiments disclosed herein, some methods and materials are described.

The terms defined immediately below are more fully described by reference to the Specification as a whole. It is to be understood that this disclosure is not limited to the particular methodology, protocols, and reagents described, as these may vary, depending upon the context they are used by those of skill in the art.

As used herein, the singular terms “a,” “an,” and “the” include the plural reference unless the context clearly indicates otherwise.

### I. Introduction

Certain embodiments described herein are new and novel apparatuses and methods relating to multiple insulated glass units (IGU), that each have an optically switchable device, positioned within and secured by structural elements, and having one or more cables electrically connected to the IGUs and routed through the structural elements. In some cases, the apparatuses may further include a controller that is configured to control operation of the IGUs and that is positioned within one of the structural elements. In some cases, the methods provided herein relate to manufacturing and assembling certain examples of apparatuses described herein.

IGUs with optically switchable devices such as, e.g., electrochromic devices, provide numerous advantages to a building, such as controlling light, heat, health, energy usage and savings, and occupant comfort, for example, of the building. However, the installation of such IGUs, corresponding cables and wires, and optionally controllers can be challenging, costly, time-consuming, and can lead to inconsistent results, damaged elements, and an inability to perform maintenance on elements of the IGU system.

For example, in some cases, each IGU may include one or more cables exiting the sealed portion of the IGU that is electrically connected to a controller configured to control the optically switchable device (e.g., electrochromic device) of that IGU. Each IGU may also include a plurality of bus bars electrically connected one or more layers of the optically switchable device. Each IGU may also be a two-pane or three-pane unit, for example, with each pair of panes separated by a spacer and the optically switchable devices may be sealed within the IGU. Electrical wires are electrically connected to the bus bars and one or more of these wires may exit the sealed portion of the IGU through the spacer, or some other location of the IGU, so that it may be electrically connected to the controller. The electrical connection between the IGU and the controller may include a plurality of connected cables or wires, such as two, three, or four. The controller is configured to control the IGU's optically switchable device by applying voltages to the bus bars.

In certain instances, some assemblies also include a smart window controller (SWC) or other controller that has a memory that can store various information about an IGU of the assembly such as the lite or IGU ID, IGU dimensions, etc. For example, an IGU cable may be connected to the SWC and the SWC is then electrically connected to the controller. The controller may be located within a structural member of the assembly. In other certain instances, the controller may be located outside the assembly and the IGU cables are routed to a position at the edge of the assembly to electrically connect to the controller outside the assembly.

During fabrication and/or installation of these IGUs and controllers, the controllers may be positioned away from the IGUs, i.e., not directly next to or adjacent each other, thereby requiring the routing of wires between the IGU and the controller. For some implementations, one single controller may be used to control multiple IGUs, such as two or four IGUs, and the cables from each IGU is to be routed to the single controller. Provided herein are apparatuses and methods relating to structural elements holding two or more IGUs and configured to receive and position cables and wires.

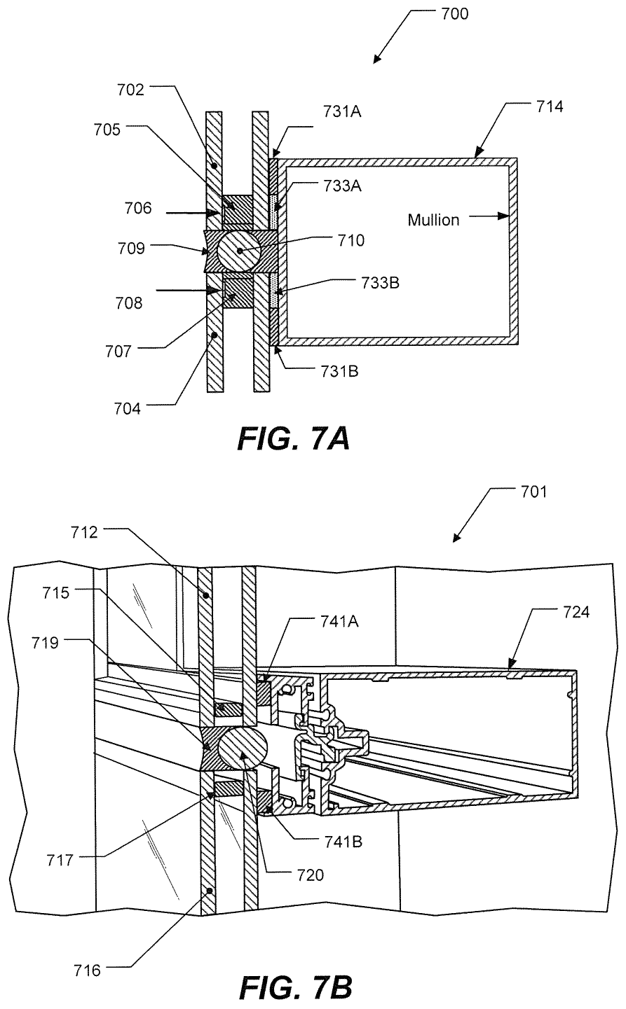

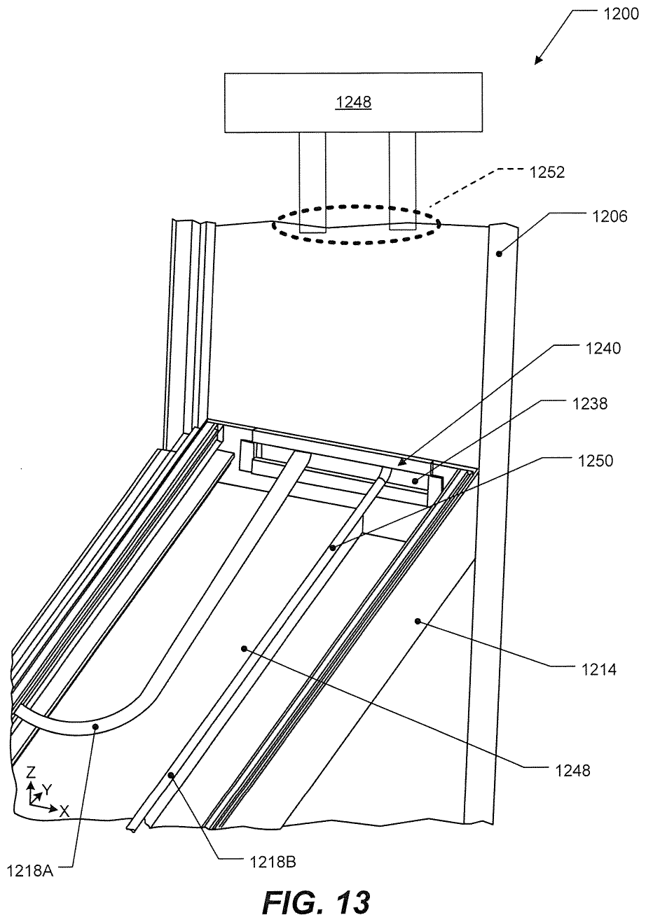

Some embodiments include assembling structural elements, IGUs, cables, and also the controller in some instances, to create a single unit or unitized package or assembly. Such single unit, or unitized assembly, may be manufactured and assembled at one location, such as a factory or shop, then transported to a location where a building is under construction, and then positioned into a frame of the building and thereby become a part of the building envelope. Using a unitized assembly can result in numerous benefits, such as a more uniform, robust, and reliable construction of the building while reducing damage, delays, needs for repairs, and costs of manufacturing and installation. Further, a unitized assembly can be commissioned and readied for integration with the building before installation, thereby reducing commissioning time, efforts, and cost. For example, a unitized assembly may a fully framed unit with cabling through structural members to a standardized location at an edge or corner of the unit to electrically connect to a standardized location at a building at which the unitized assembly is being installed. In some cases, the unitized assembly has an intermediate horizontal member interposed between two insulated glass units (IGUs) and IGU cables from the two IGUs enter the intermediate horizontal member (e.g., IGU cables 1218A and 1218B enter intermediate horizontal member 1214 in FIG. 13) and the IGU cables can pass through a horizontal member to a standardized location to electrically connect to components of the building at installation. FIGS. 7A and 7B depict examples of unitized systems 700 and 701.

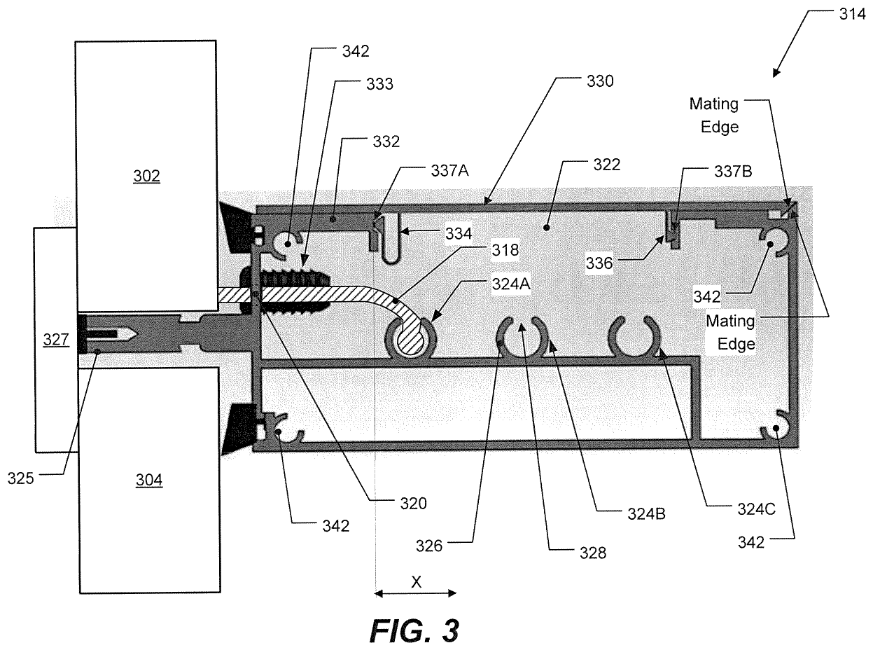

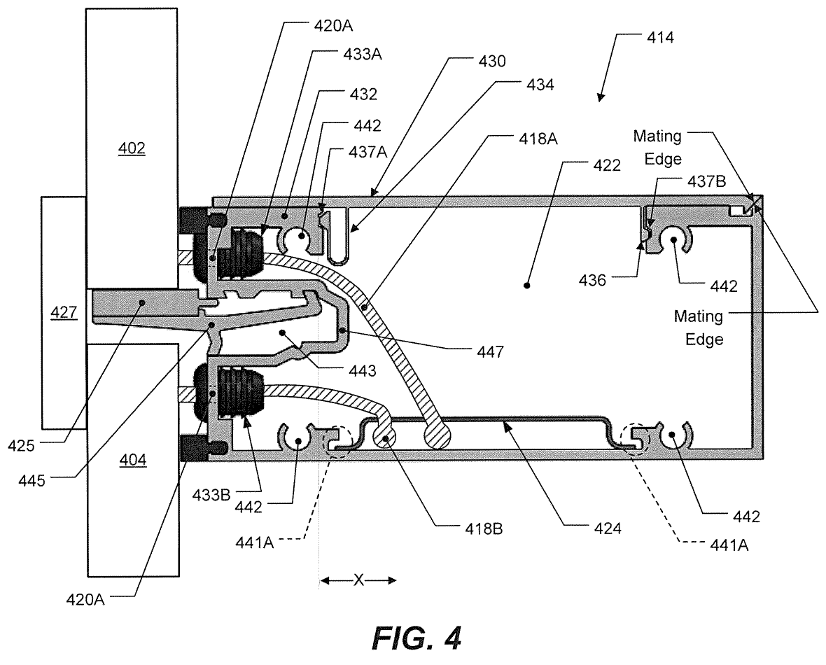

Some embodiments relate to an assembly of IGUs, cables, and also a controller in some instances, in a “stick build” configuration. In a stick build configuration, the IGUs may be connected together to create a single unit at one location and transported to the building for installation or alternatively connected together at the building. For example, an assembly in a stick build configuration may have an intermediate horizontal member (e.g., horizontal member 314 in FIG. 3 or horizontal member 414 in FIG. 4) with a pressure plate (e.g., pressure plate 327 in FIG. 3 or pressure plate 427 in FIG. 4) for connecting the IGUs. The IGU cables may pass through structural members of the assembly from the IGUs to a standardized location to electrically connect to components of the building at installation. Using an assembly in a stick build configuration in a single unit provide benefits such as more uniform, robust, and reliable construction of the building while reducing damage to the components, delays, needs for repairs, and costs of manufacturing and installation. Further, such an assembly can be commissioned and readied for integration with the building before installation, thereby reducing commissioning time, efforts, and cost.

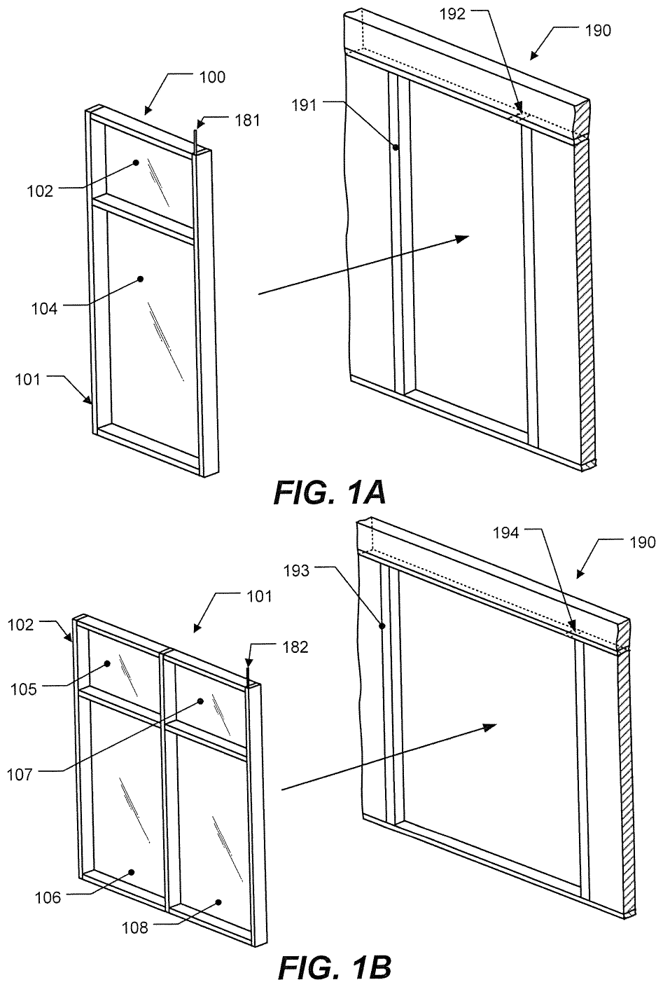

FIGS. 1A and 1B depict assemblies 100 and 101, where one or more IGU cables may be routed through structural members of their frames such that these assemblies can be commissioned and ready for integration with a building. The assemblies may be unitized assemblies or assemblies in a stick build configuration. Assembly 100 includes a frame 101 having a plurality of horizontal and vertical structural members and two insulated glass units (IGUs) 102, 104. As denoted by the dashed line, assembly 100 can be installed into a frame 191 of a building 190 such that a distal end 181 of one or more cables can be electrically connected to one or more electrical connectors 192 at a centralized location at frame 191 of the building 190. Assembly 101 includes a frame 102 having a plurality of horizontal and vertical structural members and four IGUs 105, 106, 107, and 108. As denoted by the dashed line, assembly 100 can be installed into a frame 193 of the building 190 such that a distal end 182 of one or more cables can be electrically connected to one or more electrical connectors 194 at a centralized location at frame 193 of the building 190.

### II. Examples of Assemblies

In various embodiments, an assembly may include various numbers of IGUs, vertical structural members, and horizontal structural members. In some embodiments, an assembly may include two IGUs, two vertical structural members, and three horizontal structural members. In another embodiment, an assembly may include four IGUs, three vertical structural members, and six horizontal structural members. In another embodiment, an assembly may include four IGUS, three vertical structural members, and four horizontal structural members. In other embodiments, an assembly may include four IGUs, three vertical structural members, and five horizontal structural members.

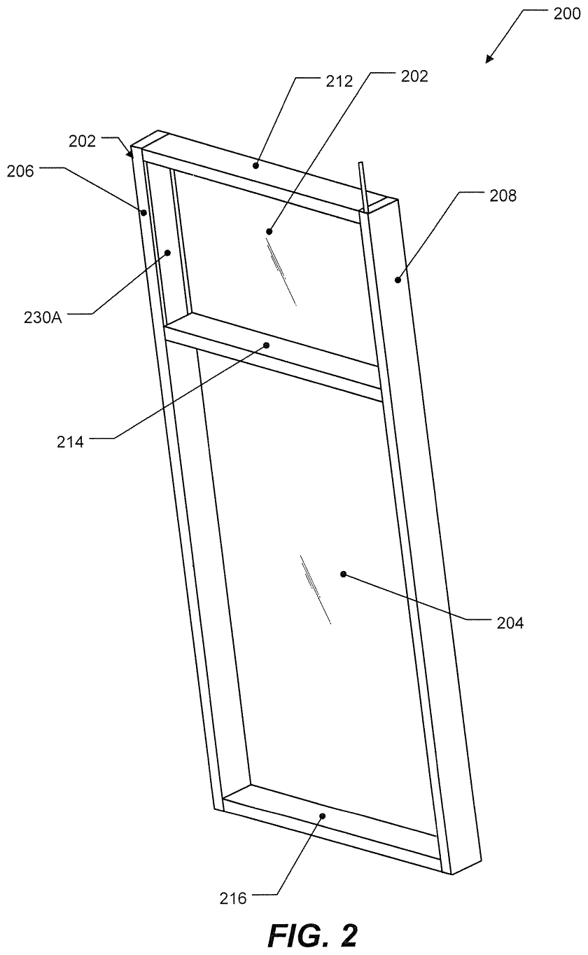

For example, FIG. 2 is a schematic drawing depicting an assembly 200 that includes two IGUs 202 and 204 and a frame 201 having two vertical structural members 206 and 208 (also referred to herein as “vertical members”) and three horizontal structural members 210, 212, and 214 (also sometimes referred to herein as “horizontal members”), for example. IGU 202 is positioned above (relative orientation in drawing) IGU 204 and horizontal structural member 214 is interposed between IGU 202 and 204. Horizontal structural member 212 may sometimes be referred to herein as an “intermediate horizontal member” or “intermediate horizontal.” Vertical structural member 206 includes a cover 230A (e.g., a removable cover) that allows access to one or more cables in the raceway of the vertical member 206, for example, while the assembly 200 is installed within a frame of a building. Assembly 200 may be a unitized assembly or an assembly in a stick build configuration.

IGU 202 and IGU 204 each have an IGU cable that is routed through a hole or port in one or more of the horizontal structural members 212, 214, and 216. For example, IGU 202 may have an IGU cable that extends through intermediate structural member 212 (sometimes referred to herein as “top horizontal member”) and IGU 204 may have an IGU cable that extends through intermediate horizontal 214. In some instances, both these IGU cables from IGU 202 and IGU 204 may extend through intermediate horizontal 214.

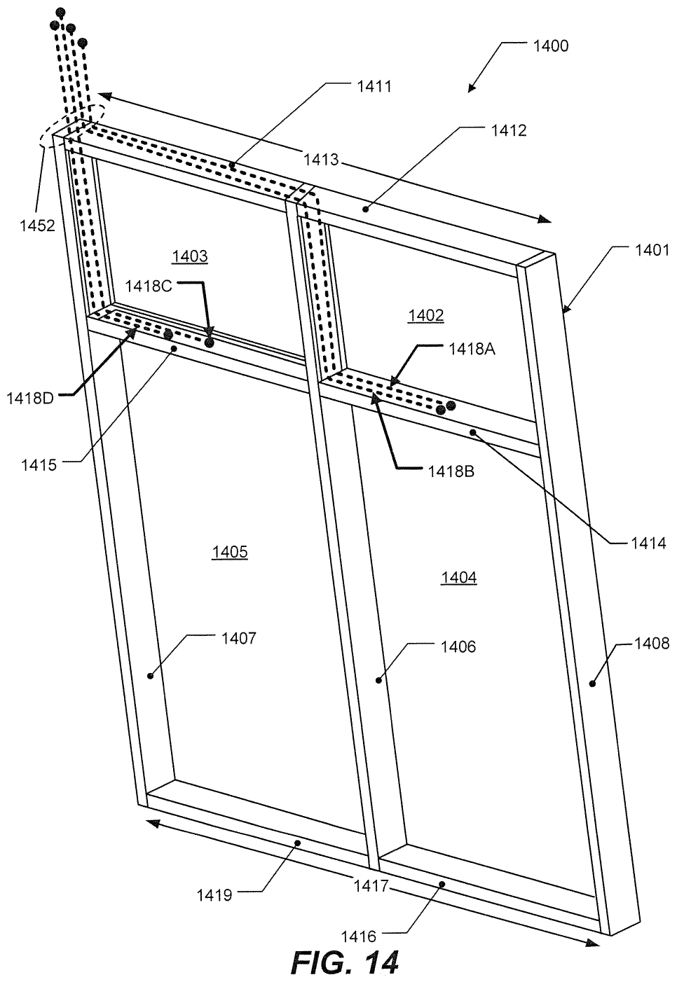

As another example, FIG. 14 is a schematic drawing depicting an assembly 1400 that includes four IGUs 1402, 1403, 1404, and 1405, and a frame 1401 having three vertical members 1406, 1407, 1408 and six horizontal members 1411, 1412, 1414, 1415, 1416, and 1419. Assembly 1400 may be a unitized assembly or an assembly in a stick build configuration. IGU 1402 is positioned above (relative orientation in drawing) IGU 1404 and intermediate horizontal member 1414 is interposed between IGU 1402 and 1404. IGU 1403 is positioned above (relative orientation in drawing) IGU 1405 and intermediate horizontal member 1415 is interposed between IGU 1403 and 1405. The assembly 1400 is shown with the removable covers on vertical members 1407 and 1408 removed. IGU 1402 includes cable 1418A, IGU 1404 includes cable 1418B, IGU 1403 includes cable 1418C, and IGU 1404 includes cable 1418D. Cable 1418A of IGU 1402 extends through horizontal member 1414 and along the cavity in horizontal member 1414, through a hole in vertical member 1406 and in its raceway upwards, then through another hole in vertical member 1406 and into top horizontal member 1411, through a hole in vertical member 1407, and out a common area 1452. Cable 1418B of IGU 1404 follows the same path as IGU cable 1418A. Cables 1418C of IGU 1403 and 1418D of IGU 1404 extend into horizontal 1415, through a hole of vertical 1407, in the raceway of vertical member 1407 and out common area 1452. In some implementations, these IGU cables 1418A-D may be connected to a single controller (not shown).

Assembly 1400 also includes a plurality of horizontal and vertical structural members. Vertical structural member 1408 and vertical structural member 1406 are on opposing sides of IGUs 1402 and 1404 such that these IGUs are interposed between these members 1408 and 1406, like with FIG. 2, for example. An intermediate horizontal member 1414 spans between vertical structural member 1406 and 1408 and between IGUs 1402 and 1404, similar to FIG. 2 and horizontal member 214 described herein. Similarly, vertical structural members 1406 and 1407 are on opposite sides of IGUs 1403 and 1405 such that these IGUs are interposed between the vertical members 1406 and 1407. An intermediate horizontal 1415 spans between vertical members 1406 and 1407 and between IGUs 1403 and 1405, similar to horizontal member 214 in FIG. 2.

### Examples of Internal Features of Assemblies

The structural members may have various features that enable the creation of the assembly with accessible internal features. For instance, a horizontal structural member may include a removable access cover that can be removed repeatedly and that can provide access to the internal aspects of the member for manufacturing and servicing, cable retention features configured to interface with one or more cables and retain the cable in one or more positions or areas, and in some instances, retention features for positioning an SWC and/or controller. In some instances, a vertical structural member may also or alternatively include a removable cover to provide access to cables, controllers, or other components therein. A removable access cover may provide access while the assembly is installed within a frame of a building in certain aspects.

The middle or intermediate horizontal structural member may also be configured in various ways to connect with the IGUs. In some instances, for example, an intermediate horizontal member may have a seat on which an IGU sits, directly or indirectly, and a pressure plate that is used to provide lateral force to help secure the IGUs to the horizontal member.

For example, FIG. 3 depicts a cross-sectional side view of a portion of an assembly (e.g., assembly 200 in FIG. 2) including IGUs 302 and 304 and a horizontal member 314 with a seat 325 upon which IGU 302 sits and a pressure plate 327. Pressure plate 327 is secured to seat 325 and horizontal member 314 in order to secure IGUs 302 and 304 to horizontal member 314. In some instances, this may be considered an example of a “stick build” or “captured glazing” configuration. In some other embodiments, the intermediate horizontal may have structural and sealing silicone as well as a backing rod that is used to secure the IGUs to the horizontal member. This configuration may be considered a “structural silicone glazing” configuration. An example of a “structural silicone glazing” configuration is illustrated in FIGS. 7A and 7B.

In FIG. 3, IGU 302 is positioned on seat 325 of horizontal member 314 and IGU 304 is beneath IGU 302 and seat 325. Horizontal member 314 includes three retention features 324A-C. Each cable retention feature 324A-C has a partial circle wall 326 with an opening 328 through which the cable can be placed, e.g., a C-shaped opening. IGU 302 includes an IGU cable 318A that extends from IGU 302, through a portion of horizontal member 314, e.g., through a hole 320, into a cavity 322 of horizontal member 314, and into cable retention feature 324A. Cable retention feature 324A is configured to receive a cable such as IGU cable 318 and restrain the cable in one or more directions of movement or area. A grommet 333 may be used to position IGU cable 318 within hole 320 and prevent the material of horizontal member 314 from damaging IGU cable 318.

Horizontal member 314 also includes a removable cover 330. Removable cover 330 is configured to be connected to a body 332 of horizontal member 314 with an elastic member 334 and a clip 336 offset from each other. Elastic member 334 has a U-shape and is deformable in a lateral direction denoted as X, e.g., towards and away from IGUs 302 and 304. When removable cover 330 is pushed towards IGU 302 (such as with suction cups), elastic member 334 is elastically deformed and allows for clip 336 to become unrestrained or unseated from a notch, divot, or seat in body 332. The notch 337A of body 332 is configured to engage with elastic member 334 and notch 337B of body 332 is configured to engage with clip 336. Once clip 336 is free from body 332, cover 330 can be removed and the internal features of cavity 322 of horizontal member 314 can be accessed for maintenance or service, for example. Horizontal member 314 also includes four connection means 342, e.g., holes, each connection means 342 can be, for example, threaded in order to each receive a screw passed through a vertical member and into horizontal member 314.

As another example, FIG. 4 depicts a cross-sectional side view of a portion of an assembly (e.g., assembly 200 in FIG. 2) including IGUs 402 and 404 and a horizontal member 414 and a pressure plate 427. Pressure plate 427 is secured to seat 425 and horizontal member 414 in order to secure IGUs 402 and 404 to horizontal member 414. Horizontal member 414 has a body 432 that includes a recess 443 having a boundary element 447 that extends into a cavity 422 and is configured to receive and connect with a structural member 445 including seat 425. This structural member 445 may be a single unitary, monolithic body, e.g., made of a single piece of material, that includes a seat 425 for supporting IGU 402. In some cases, structural member 445 may also be used to provide additional support to assembly 414.

In FIG. 4, IGU 402 is positioned on seat 425 of horizontal member 414 and IGU 404 is beneath IGU 402 and seat 425. Horizontal member 414 include two holes 420A and 420B through which IGU cables 418A and 418B from IGUs 402 and 404, respectively, extend into cavity 422 of horizontal member 414, along with corresponding grommets 433A and 433B. Horizontal member 414 also includes one or more clips 424 that may be used to restrain some movement of IGU cables 118A and 118B. Horizontal member 314 includes a first notch 441A and a second notch 441B that are configured to receive portions of clip 424 and restrain at least some movement of clip 424. In some implementations, like in FIG. 4, the horizontal member may also include one or more clip retention features, such as notches, grooves, channels, slots, or other features that are configured to receive a portion of the clips and restrain at least some movement of the clips.

Grommet 333A may be used to position IGU cable 418A within hole 420A and prevent the material of horizontal member 414 from damaging IGU cable 418A. Grommet 333B may be used to position IGU cable 418B within hole 420B and prevent the material of horizontal member 414 from damaging IGU cable 418B. Horizontal member 414 also includes four connection means 442, e.g., holes, that can be threaded in order to each receive a screw passed through a vertical member of the assembly into the horizontal member 414.

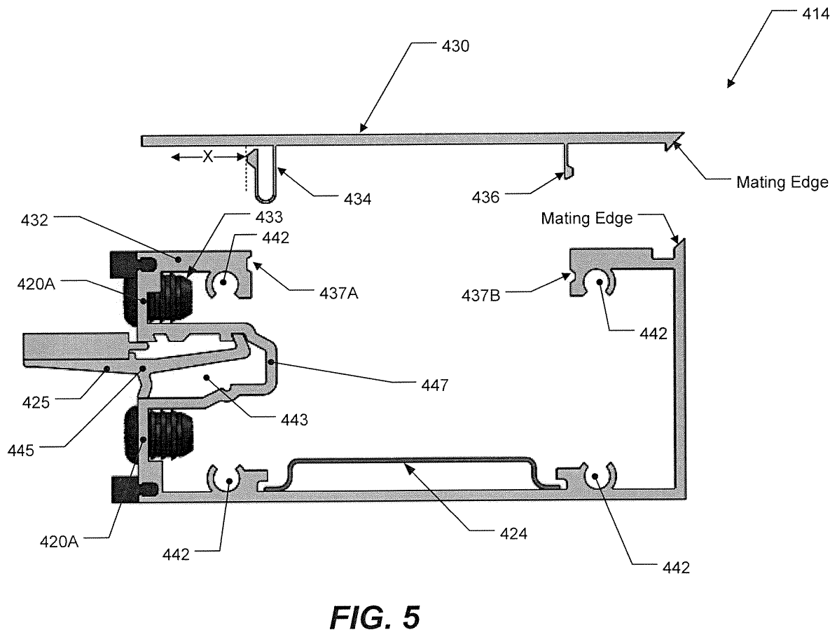

Horizontal member 414 also includes a removable cover 430. Removable cover 430 is configured to be connected to a body 432 of horizontal member 414 with an elastic member 434 and a clip 436 offset from each other. Elastic member 434 has a U-shape and is deformable in a lateral direction denoted as X, e.g., towards and away from IGUs 402 and 404. When removable cover 430 is pushed towards IGU 402 (such as with suction cups), elastic member 434 is elastically deformed and allows for clip 436 to become unrestrained or unseated from a notch, divot, or seat in body 432. The notch 437A of body 432 is configured to engage with elastic member 434 and notch 437B of body 432 is configured to engage with clip 436. Once clip 436 is free from body 432, cover 430 can be removed and the internal features of cavity 422 of horizontal member 414 can be accessed for maintenance or service, for example. FIG. 5 depicts the horizontal member 414 in FIG. 4 with removable cover 430 exploded away from the horizontal member 414. The cover 430 is configured to be connected with body 432 of horizontal member 414 without using adhesives, screws, or nails, but rather with an elastic member 434 and a clip 436 offset from each other. Horizontal member 414 also includes four connection means 442, e.g., holes, each connection means 442 can be, for example, threaded in order to each receive a screw passed through a vertical member and into horizontal member 414.

In some implementations, a horizontal member may be used with a pressure plane similar to the pressure plate 327 in FIG. 3 or the pressure plate 427 shown in FIG. 4. In some other embodiments, a horizontal member may be used without a pressure plate in, for example, a structural silicone glazing configuration such as illustrated in FIGS. 7A and 7B.

In some instances, a horizontal structural member of an assembly, including cable retention features, may have a single profile that can be extruded, or manufactured by extrusion. In some embodiments, the cable retention features may extend for the entire length of the horizontal member (e.g., intermediate horizontal member), while in some other embodiments the cable retention features may be less than the length, such as at least about 95% of the length, at least about 85% of the length, at least about 75% of the length, at least about 65% of the length, at least about 55% of the length, at least about 45% of the length, at least about 35% of the length, or at least about 25% of the length.

In some implementations, a structural member (e.g., horizontal member and/or vertical member) of an assembly may include a removable cover that covers the recess and that can be non-destructively removed to allow for maintenance and servicing of internal components within the structural member. In some cases, the removable cover is secured to the structural member without using adhesives, screws, or nails, but rather with, e.g., an elastic member that can be elastically deformed and seated within a notch, divot or seat in a body of the structural member.

An example of a removable cover is the removable cover 430 shown in FIGS. 4 and 5. In FIG. 5, removable cover 430 is shown removed from body 432 of horizontal member 414. Removable cover 430 is configured to be connected with the body 432 of the horizontal member 414 without using adhesives, screws, or nails, but rather with an elastic member 434 and a clip 436 offset from each other. The elastic member 434 has a U-shape and is deformable in a lateral direction X, e.g., towards and away from the IGUs. When the removable cover 430 is pushed towards IGU 402 (such as with suction cups), the elastic member 434 is elastically deformed and allows for clip 436 to become unrestrained or unseated from a notch, divot, or seat in body 432. In FIGS. 4 and 5, notch 437A of body 432 is configured to engage with elastic member 434 and notch 437B of body 432 is configured to engage with clip 436. Once clip 436 is free from body 432, cover 430 can be removed and the internal features of cavity 422 of the horizontal member 414 can be accessed for maintenance or service, for example.

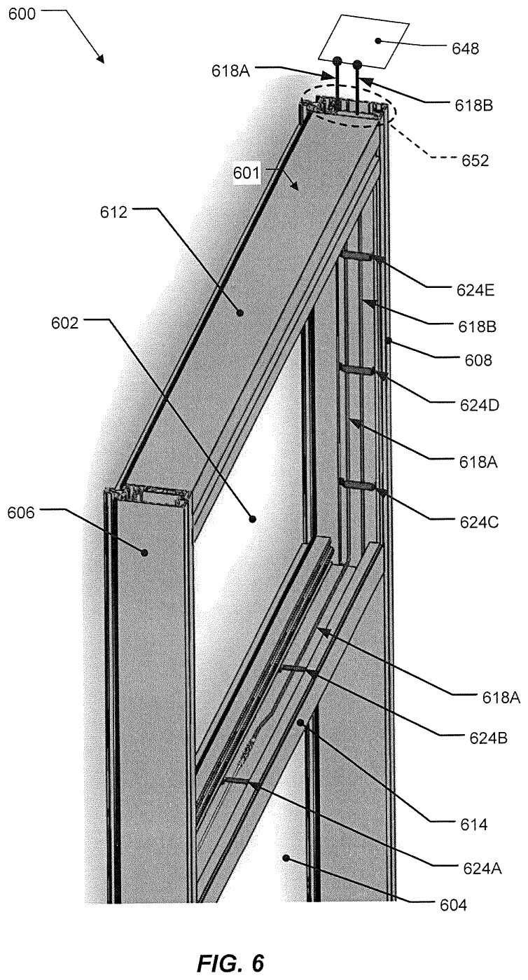

Another example of a removable cover is cover 330 in FIG. 3. The removable cover 330 is configured to be connected with body 332 of horizontal member 314 with an elastic member 334 and a clip 336 offset from each other. Elastic member 334 has a U-shape and is deformable in a lateral direction X, e.g., towards and away from the IGUs. When removable cover 330 is pushed towards IGU 302 (such as with suction cups), elastic member 334 is elastically deformed and allows for clip 336 to become unrestrained or unseated from a notch, divot, or seat in body 332. The notch 337 of body 332 is configured to engage with elastic member 334 and notch 337 of body 332 is configured to engage with clip 336. Once clip 336 is free from body 332, cover 330 can be removed and the internal features of cavity 322 of horizontal member 314 can be accessed for maintenance or service, for example. As another example, horizontal member 614 and vertical member 608 are shown in FIG. 6 with their removable covers removed.

In some embodiments, to make the connection between a cover and the body of a horizontal member aesthetically pleasing, a mating edge of the cover may be at an angle that is complimentary to a mating edge of the body. For example, in FIGS. 4 and 5, a mating edge at removable cover 430 and is at an angle (e.g., about 45 degrees) that is complimentary to a mating edge of the body 432 of horizontal member 414. As another example, in FIG. 3, a mating edge at removable cover 330 and is at an angle (e.g., about 45 degrees) that is complimentary to a mating edge of the body 332 of horizontal member 314. By having these angles complimentary, or substantially complimentary (e.g., within 5% of complimentary), a seam between the cover and body may not be visible, or noticeably visible. For example, in some embodiments, each of these mating edges may be 45 degrees.

In some embodiments, cable retention features may be used to interface with one or more cables and retain the one or more cables in position(s) or area(s). For example, in FIG. 3, horizontal member 314 includes three retention features 324A-C. Each cable retention feature 324A-C has a partial circle wall 326 with an opening 328 through which the cable can be placed, e.g., a “C-shape.” In some instances, the opening may be sized larger than, or smaller than, the diameter of the cable 318. By having the opening smaller, the cable may be pressed through the opening and then prevented from at least some movement out of the opening. In other embodiments, other cable retention features may be used, such as a plurality of clips or fasteners for each cable that are offset from each other along a portion of the horizontal member.

As another example, FIG. 4 depicts a cross-sectional side view of a portion of an assembly including IGUs 402 and 404 and a horizontal structural member 414 with one or more clips 424 that may be used to restrain some movement of IGU cables 418A and 418B. The assembly may be a unitized assembly or an assembly in a stick build configuration. Horizontal member 414 in FIGS. 4 and 5 includes some features and configurations that are the same as horizontal member 314 in FIG. 3, and some that are different than those of horizontal member 314 in FIG. 3. Horizontal member 414 of FIGS. 4 and 5 includes a removable cover 430 and features for connecting with removable cover 430 which may be the same as those of removable cover 330 in FIG. 3. FIG. 5 depicts the horizontal structural member 414 in FIG. 4 with removable cover 330 removed.

One or both of the vertical members may be configured to have one or more cables routed from a horizontal structural member, through the vertical member, and to a common location of the unitized assembly or outside the unitized assembly. In some instances, the common location may be where the plurality of cables terminate at the controller. The configuration of the vertical members may include, in some embodiments, a channel or “raceway”, where one or more cables may be positioned and routed, as well as a hole aligned with a horizontal structural member that's configured to allow one or more cables to extend between the vertical member and the horizontal structural member. In some embodiments, the vertical members may also have a cover similar to that of the horizontal member cover 330 or 430 described above to allow access to the cables in the vertical members raceway. These covers may be on the internal side that are adjacent to the IGU. FIG. 3 identifies one example of such cover as 330. FIG. 4 identifies one example of such cover as 430.

FIG. 6 depicts a partial off-angle view of the assembly 600 having a frame 601 with a first horizontal member 612 having cable retention features that may be similar to horizontal member 312 of FIG. 3, for example. Assembly 600 may be a unitized assembly or an assembly in a stick build configuration. Assembly 600 also includes two IGUs 602, 604. The frame 601 includes two vertical members 606, 608, the first horizontal member 612, a second horizontal member 614, and a third horizontal member (not shown). Second horizontal member 614 is interposed between IGU 602 and 604 and is considered an intermediate horizontal member. Vertical member 608 includes a removable cover (not shown) and intermediate horizontal member 614 includes a removable cover (not shown). Intermediate horizontal member 614 and vertical member 608 are shown without their removable covers in order to view internal components.

In FIG. 6, intermediate horizontal member 614 includes cable retention features that are clips 624A and 624B for retaining some movement of IGU cable 618A. The clips in an assembly may be spaced apart from each other by various distances. As also seen in FIG. 6, vertical member 608 includes cable retention features that are clips 624C-E configured to retain IGU cables 618A and 618B positioned in the raceway or other cable routing features of vertical member 608.

In FIG. 6, IGU 602 has an IGU cable 618A and IGU 604 has an IGU cable 618B that are routed through a hole or port in one or more of the structural members to a common location 652 to electrically connect to a controller 648 configured to control the IGUs 602, 604. IGU cable 618A extends through intermediate horizontal member 614. In other instances, both IGU cables 618A and 618B may extend through intermediate horizontal member 614. Intermediate horizontal member 614 also includes two cable retention features 624A and 624B that are configured to receive IGU cable 618A and restrain the cable in one or more directions of movements or areas. In some instances, cable retention features 624A and 624B may be similar to cable retention features 324A-324C in FIG. 3. Vertical member 608 includes three cable retention features 624C-E that are configured to receive IGU cables 618A and 618B and restrain the cables in one or more directions of movements or areas.

As noted above, in some embodiments the intermediate horizontal may be configured with structural and sealing silicone as well as a backing rod that is used to secure the IGUs to the horizontal member as opposed to a seat (e.g., seat 325 in FIG. 3 or seat 425 in FIG. 4). FIGS. 7A and 7B depict two examples of such intermediate horizontal member configurations.

FIG. 7A is an illustrative diagram of components of an assembly 700 having two IGUs 702 and 704 and a horizontal member 714, according to an implementation. The body of a horizontal member may sometimes be referred to as a “mullion.” First IGU 702 includes an IGU spacer 705 and a seal between the spacer 705 and the two lites. First IGU 702 also includes a bus bar 706. Second IGU 704 includes an IGU spacer 707 and a seal between the spacer 707 and the two lites. Second IGU 704 also includes a bus bar 708. Further, the IGUs 702 and 704 are secured to the horizontal member 714 with a structural seal 731A (e.g., structural silicone) and structural seal 731B, spacers 733A and 733B, a weather sealant 709 (e.g., silicone sealant), and a backer rod 710. Structural seal 731A is between first IGU 702 and horizontal member 714. Structural seal 731B is between second IGU 704 and horizontal member 714. Spacer 733A is between first IGU 702 and horizontal member 714. Spacer 733B is between second IGU 704 and horizontal member 714. Backer rod 710 is vertically interposed between the IGUs 702 and 704. Weather seal sealant 709 is placed on the backer rod 710.

FIG. 7B is an illustrative image of components of an assembly 701 having two IGUs 712 and 714 and a horizontal member 724, according to an implementation. First IGU 712 includes an IGU spacer 715. Second IGU 714 includes an IGU spacer 717. IGUs 712 and 714 are secured to horizontal member 724 with structural silicone 741A and 741B, spacers between the IGUS 712 and 714 and the horizontal member 724, a backer rod 720, and weather seal silicone sealant placed on the backer rod 720. Structural silicone 741A is between first IGU 712 and horizontal member 724. Structural silicone 741B is between second IGU 714 and horizontal member 724. Backer rod 720 is vertically interposed between the IGUs 712 and 714.

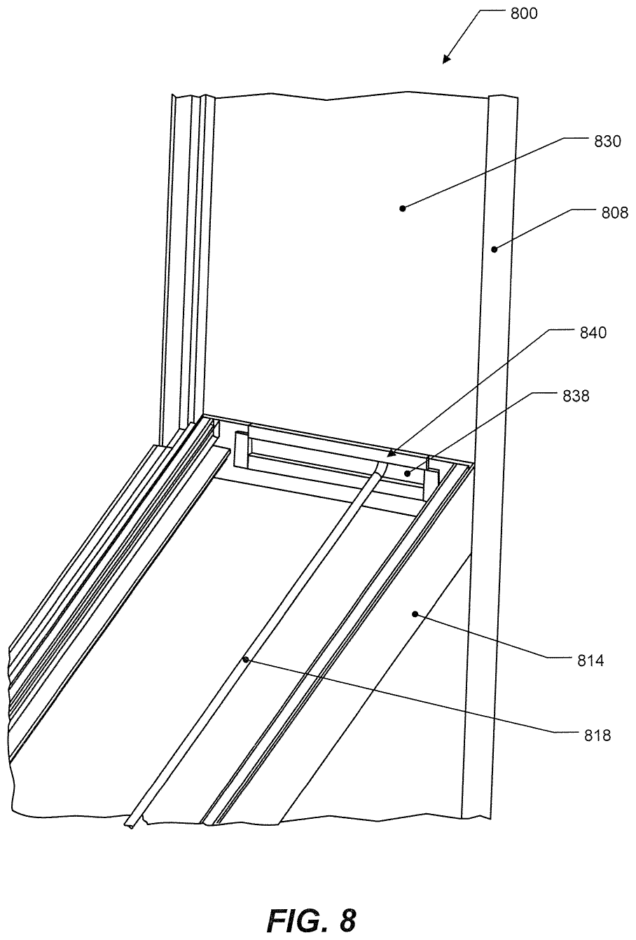

FIG. 8 depicts an off-angle view of an example of components of an assembly 800 that may be part of assembly 200 in FIG. 2, according to one implementation. Assembly 800 may be a unitized assembly or an assembly in a stick build configuration. Assembly 800 includes a horizontal member 814 with its cover being transparent or its cover removed. Here, vertical structural member 808 includes a hole 838 aligned with the horizontal structural member 814 and that provides an opening for the cable 818 to pass through in order to extend into the raceway (not visible in this Figure) of the vertical member 808.

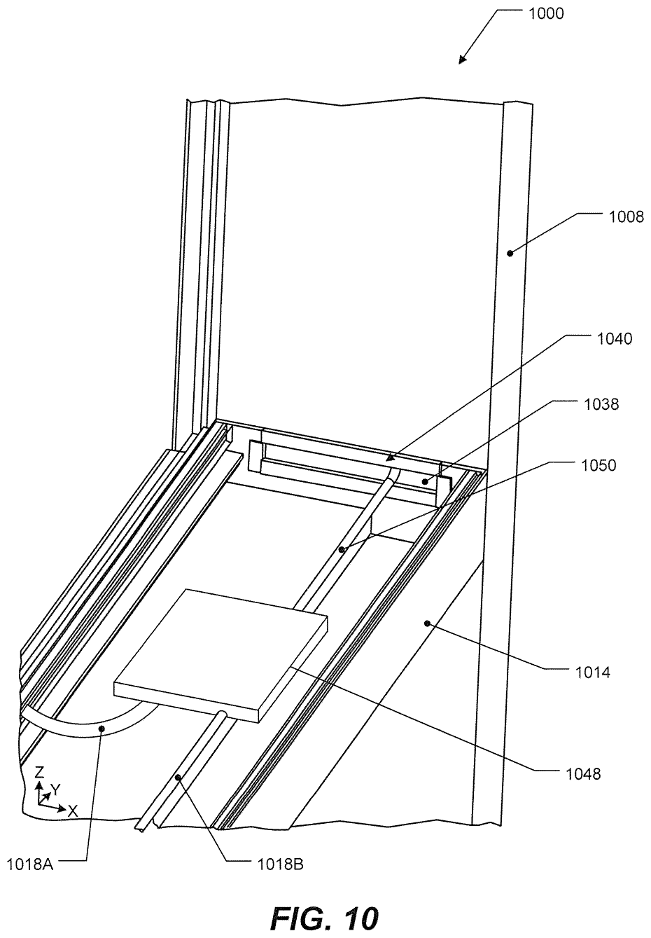

In examples with an alignment between the hole and the horizontal structural member, the alignment may include the horizontal structural member covering or extending around the hole (e.g., hole 838), such as depicted in FIG. 8. It may be advantageous to configure the size and/or shape of the hole to allow the cable passing through the hole some movement and flexibility for routing and positioning during manufacturing, assembly, and service, for example. The shape may be a circle, rectangle, obround, elliptical, square, for instance. In some cases, the hole may also have one or more polymer members or other protective materials on at least one or more edges or surfaces of the hole to prevent the metal vertical member from damaging or impinging the cable. For example, hole 838 in FIG. 8 includes one or more polymer members 840 on one or more edges or surfaces of hole 838 to prevent the metal vertical member from damaging or impinging the cable 818. As another example, For example, hole 1038 in FIG. 10 includes one or more polymer members 1040 on one or more edges or surfaces of hole 1038 to prevent the metal vertical member from damaging or impinging the cable 1018B.

As noted above, at least one vertical member of an assembly may have, in some implementations, a removable cover to allow access to one or more cables in the raceway. For example, vertical member 808 in FIG. 8 includes a removable cover 830. The removable cover and vertical member may have similar connection features as described herein with respect to FIG. 3, such as an elastic member 334 and a clip 336.

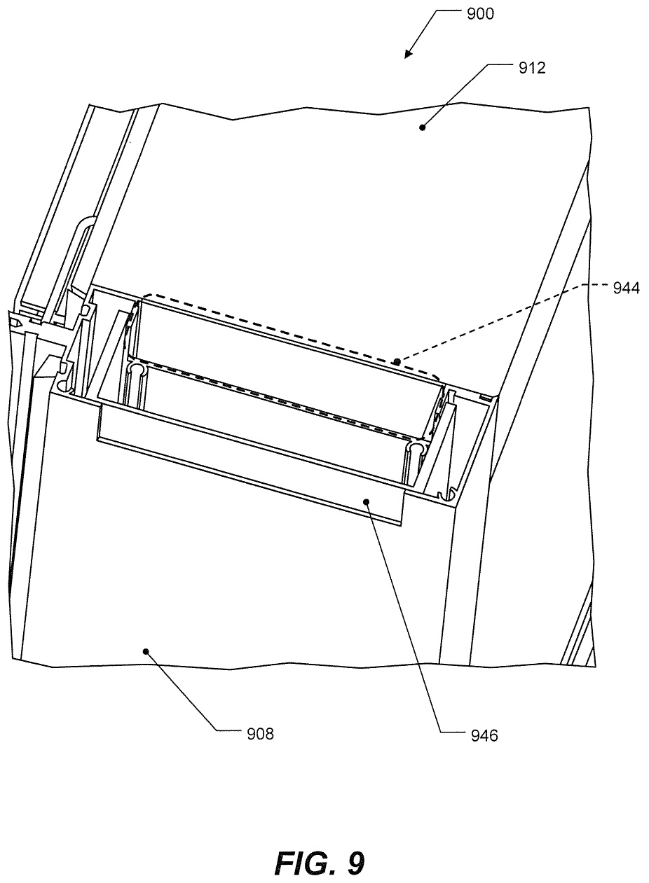

FIG. 9 depicts an off-angle view of an example of components of an assembly 900 that may be another part of assembly 200 in FIG. 2, according to one implementation. Assembly 900 may be a unitized assembly or an assembly in a stick build configuration. This example shows the top of vertical member 908 visible and a portion of the top horizontal member 912. The vertical member 908 includes a raceway 944, encompassed by the dashed line shape, and a cavity that is U-shaped for containing a structural beam 946, e.g., a steel beam. The IGU cables (not shown) extending from horizontal member 912 can be positioned in raceway 944 so that the IGU cables can be routed vertically within assembly 900. Other cables may also be positioned in raceway 944, such as a trunkline (e.g., a coax cable connected to another controller or control panel, such as a Class 1 or Class 2 control panel, or a drop line from a trunkline).

In some instances, the connection between vertical member and the horizontal members may use a shear block. The shear block may be secured to the vertical member and the horizontal member may be slid onto the shear block and then secured to the shear block. In some other instances, the connection between vertical member and the horizontal members may not use a shear block. In some implementations, for example, the horizontal member may include a plurality of connection means, such as threaded holes, or bolt through holes, to receive a screw or bolt passed through a hole on the vertical member. Referring back to FIG. 3, for example, horizontal member 314 includes four connection means 342, e.g., holes, that can be threaded in order to each receive a screw passed through the vertical member and into the horizontal member. As another example, referring back to Figure horizontal member 414 includes four connection means 442, e.g., holes, that can be threaded in order to each receive a screw passed through the vertical member and into the horizontal member.

In some embodiments, the single controller that is connected to, and configured to control, the IGUs (e.g., IGUs 202 and 204) in an assembly (e.g., assembly 200) may be positioned inside a horizontal structural member (e.g., horizontal member 212, 214, or 216 in FIG. 2) or inside a vertical structural member (e.g., vertical member 206 or 208 in FIG. 2). In some implementations, the controller may be positioned in a horizontal member and this member may include one or more connection features for connecting to the controller, such as threaded connections. For example, FIG. 10 depicts an off-angle view of an example of components of an assembly 1000 with two IGUs and a controller 1048 positioned inside an intermediate horizontal structural member 1014, according to an implementation. The assembly includes IGU cables 1018A, 1018B from the IGUs that may both enter into horizonal member 1014 and connect to the controller 1048. For instance, cable 1018A from a first IGU and cable 1018B from a second IGU both enter into the cavity of horizontal member 1014 and connected to the controller 1048 also positioned in the member 1014.

In some instances, a controller may be connected to another cable that may be electrically connected to a network or infrastructure of a building, such as a trunk line that is connected, directly or indirectly, to the control panel. For example, in FIG. 10, controller 1048 is connected to a cable 1050 that may be electrically connected to a network or infrastructure of a building. This other cable, sometimes referred to as a dropline, may extend through the raceway of a vertical member (e.g., vertical member 1006 or 1008) and the corresponding hole (e.g., hole 1038) in the vertical member in order to reach the controller in the horizontal member (e.g., horizontal member 1014). For example, in FIG. 10, cable 1050 extends through the raceway of vertical member 1008 and the corresponding hole 1038 in the vertical member 1008 in order to electrically connect to the controller 1048 in horizontal member 1014. In another example, the controller may be positioned in the top or bottom horizontal member and the cable of the adjacent IGU may extend through that horizontal member and connected to the controller. The other IGU cable may pass through one of the other horizontal members, through the raceway of a vertical member, and then through the horizontal member where the controller is positioned. The dropline may also run through the horizontal member where the controller is positioned.

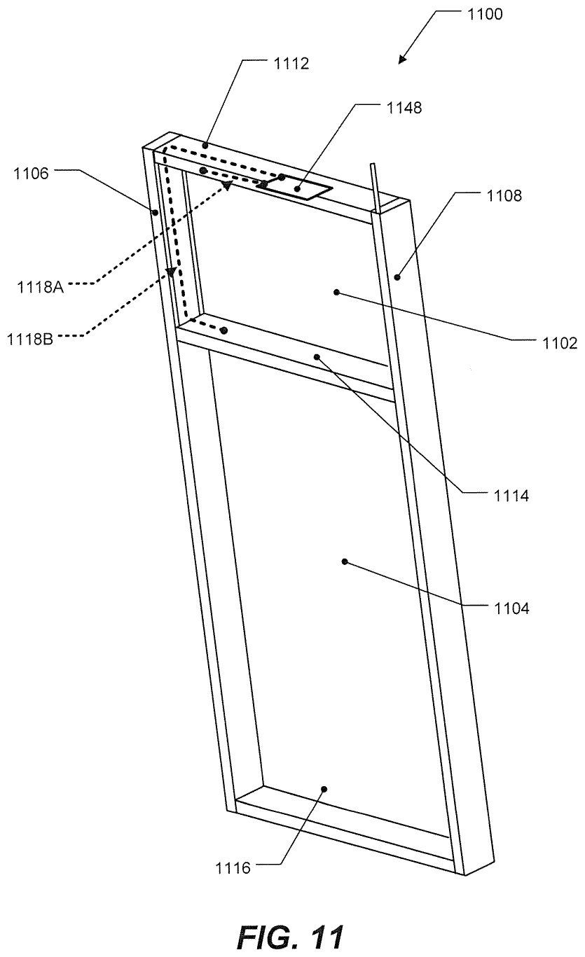

As another example, FIG. 11 depicts an off-angle view of an example of components of an assembly 1100 with two IGUs 1102, 1104 and a controller 1148 positioned inside a first horizontal member 1112, according to an implementation. Assembly 1100 may be a unitized assembly or an assembly in a stick build configuration. Assembly 1100 also includes an intermediate (second) horizontal member 1114, a third horizontal member 1116, and two vertical members 1106, 1108. The assembly 1100 also includes IGU cables 1118A, 1118B from IGU s 1102, 1104 respectively that both enter horizonal member 1114 and connect to controller 1148. For instance, cable 1118A from IGU 1104 and cable 1018B from IGU 1102 both enter into the cavity of horizontal member 1112 and connected to controller 1148 also positioned in the member 1112. In FIG. 11, IGU cable 1118A of IGU 1102 extends through first horizontal member 1112 and to controller 1148, and IGU cable 1118B of IGU 1104 extends through second horizontal member 1114, the hole on vertical member 1106, through the raceway of vertical member 1106, through another hole in vertical member 1106 aligned with first horizontal member 1112, and through first horizontal member 1112 to controller 1148. This same configuration could be mirrored with the second horizontal member 1114.

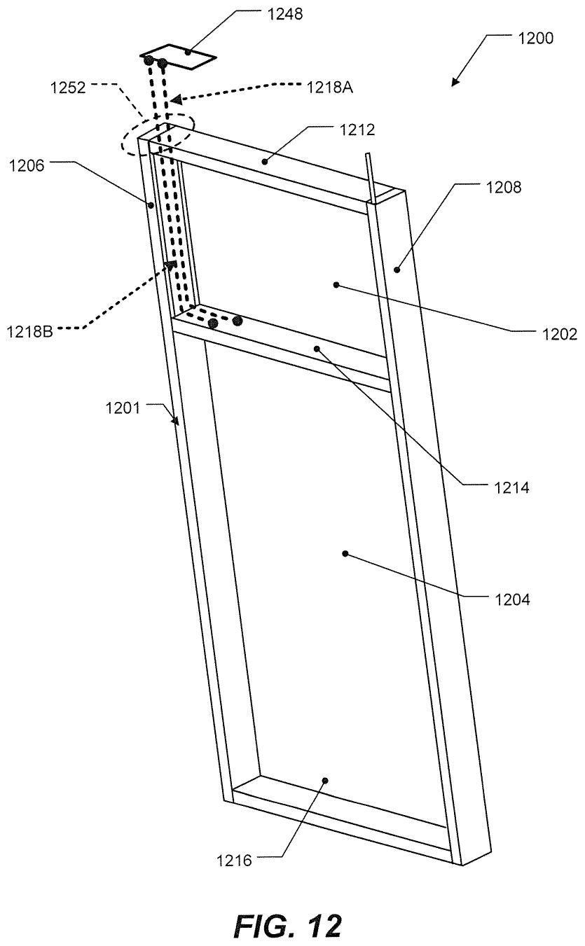

In some embodiments, the controller may be positioned outside of the assembly, such as depicted in FIGS. 12 and 13. In such implementations, it may be advantageous to route the cables within the assembly so they exit the assembly envelope/boundary at a common location. For example, FIG. 12 depicts an off-angle view of an example of components of an assembly 1200 with two IGUs 1202, 1204 and a controller 1248 positioned outside of the envelope of the assembly 1200, according to an implementation. Assembly 1200 may be a unitized assembly or an assembly in a stick build configuration. Assembly 1200 also includes a frame 1201 having an intermediate (second) horizontal member 1214, a third horizontal member 1216, and two vertical members 1206, 1208. The assembly 1200 also includes IGU cables 1218A, 1218B of the IGUs 1202, 1204 respectively. Assembly 1200 also includes a horizontal member 1214 with its removable cover being transparent or its cover removed.

In FIG. 12, IGU cables 1218A, 1218B of the IGUs 1202, 1204 extend through the intermediate horizontal member 1214, into vertical member 1206, and out of that member to the controller 1248. IGU cable 1218A of IGU 1202 extends into horizontal 1214, then through a hole in vertical 1206 and into the raceway of vertical 1206, and out the top of vertical 1206. This opening in the vertical 1206 where the IGU cables 1218A and 1218B exit may be the common location 1252. IGU cable 1218B of IGU 1204 also extends into the intermediate horizontal 1214, then through the same hole in vertical 1206 and into the same raceway of vertical 1206, and out the top of vertical 1206. These two cables 1218A and 1218B then may be electrically connected to the controller 1248. Similar cable routing may be seen in FIG. 6. IGU cable 618A is routed through intermediate horizontal 614 and both IGU cables 618A and 618B are routed through the raceway of vertical member 608 and out common area 652 to controller 648. IGU cable 618B may also be routed through horizontal member 614 according to another implementation.

FIG. 13 depicts a partial magnified view of a portion of assembly 1200 in FIG. 12, according to an implementation. In the illustrated example, the cover of the horizontal member 1214 is transparent or removed. In FIG. 13, IGU cables 1218A and 1218B are shown entering the same intermediate horizontal 1214, extending through the same hole 1238 of the vertical 1206, through the raceway of vertical 1206, and out the top of vertical 1206 at the common location 1252 and to the controller 1248. The hole 1238 may also have one or more polymer members 1240 on at least one or more edges or surfaces of the hole 1238 to prevent the metal vertical member from damaging or impinging the cable.

In some embodiments, one or more of assembly 100 of FIG. 1, assembly 200 of FIG. 2, assembly 500 of FIG. 5, assembly 700 of FIG. 7, assembly 800 of FIG. 8, assembly 900 of FIG. 9, assembly 1000 of FIG. 10, assembly 1100 of FIG. 11, assembly 1200 of FIG. 12 and FIG. 13, or assembly 1400 of FIG. 14 may be considered a single “unit” that is a unitized assembly or an assembly of a stick build configuration. Further, some embodiments of this single unit may have the cables from both IGUs extending into the intermediate horizontal member, into one vertical member, along its raceway and out its top. One example is shown in FIGS. 12 and 13. Here, the intermediate horizontal member is configured to receive and route both cables, e.g., by using clips or other retention features, to one of the vertical members. The intermediate horizontal member is configured to have a removable cover as described herein, for example. The vertical member 1206 may also have a removable cover, such as at the location where the cables are routed, e.g., the top portion where IGU 1202 is located. By using this configuration, the top and bottom horizontal members 1212 and 1216, respectively, may not need or have a cover; instead they may have a body that is a unitary body that may be extruded, for example. Further, one or both the vertical members may have the raceway for routing the cables; in some instances only one vertical member, e.g., member 1206 has a raceway while member 1208 does not.

One or more of assembly 100 of FIG. 1, assembly 200 of FIG. 2, assembly 500 of FIG. 5, assembly 700 of FIG. 7, assembly 800 of FIG. 8, assembly 900 of FIG. 9, assembly 1000 of FIG. 10, assembly 1100 of FIG. 11, assembly 1200 of FIGS. 12 and 13, or assembly 1400 of FIG. 14 provided herein may be configured to be connected to and interfaced with other such assemblies. This may include providing male and female features on the vertical members. Further, in some implementations, the IGUs and cables of two assemblies may be connected to one single controller that is configured to control four IGUs.

In some embodiments, the controller may be connected to the assembly at a later stage of fabrication. For example, assembly 200 of FIG. 2 may be manufactured and/or assembled at one location or stages, then at a later stage or at a different location, the controller may be connected to the IGU cables of the assembly.

Some embodiments may have structural members and four IGUs that may be connected to a single controller. In some instances, the controller may be positioned within one of the structural members and in other instances, the controller may be positioned outside of the envelope of the assembly. FIG. 14 depicts an assembly 1400 that includes structural members and four IGUs 1402, 1403, 1404, and 1405 with their cables 1418A, 1418B, 1418C, and 1418D routed through the members. Assembly 1400 may be a unitized assembly or an assembly in a stick build configuration.

In FIG. 14, IGU 1402 has a cable 1418A, IGU 1404 has a cable 1418B, IGU 1403 has a cable 1418C, and IGU 1404 has a cable 1418D. Assembly 1400 also includes a plurality of horizontal and vertical structural members. Vertical structural member 1406 and vertical structural member 1408 are on opposing sides of IGUs 1402 and 1404 such that these IGUs are interposed between these vertical structural members 1406 and 1408, like with FIG. 1B, for example. An intermediate horizontal member 1414 spans between vertical structural member 1406 and 1408. Similarly, vertical structural members 1406 and 1407 are on opposite sides of IGUs 1403 and 1405 such that these IGUs are interposed between the members 1406 and 1407. An intermediate horizontal 1415 spans between vertical members 1406 and 1407.

The top and bottom horizontal members may be configured in various ways in order to accomplish structural and/or aesthetic purposes. In some embodiments, the top horizontal member may be a single piece that spans between the two outer vertical members. In some of these instances, the middle vertical may meet or interface with a bottom surface or portion of the top horizontal member. For example, referring to FIG. 14, although not depicted in this Figure, the top horizontal, represented by line 1413, may span between vertical members 1407 and 1408 and the middle vertical member 1406 may intersect and interface with a bottom portion of this top horizontal member.

In some other embodiments, the top of the assembly 1400 may have two horizontal structural members like shown in FIG. 14. Here, the top horizontal member 1412 spans between vertical structural member 1406 and 1408, and the top horizontal member 1411 spans between vertical structural member 1406 and 1407. The middle vertical member 1406 in this implementation may form a portion of the top surface of assembly 1400.

In some cases, the bottom horizontal member may be similarly configured like the top and intermediate horizontal members. For example, the bottom horizontal member may be a single body 1417 that extends between the outer vertical members 1407 and 1408, like top horizontal member 1411. In some other implementations, the bottom horizontal section may have two horizontal members that each span between the middle vertical member 1406 and one of the outer vertical members, 1407 or 1408. In FIG. 14 this is illustrated with the horizontal member 1416 extending between vertical members 1407 and 1408.

In some instances, both the top and bottom horizontal members may be configured the same, such as having two top horizontal members and two bottom horizontal members, like shown in FIG. 14. In some other embodiments, the top and bottom horizontal members may each be a single member extending between the outer vertical members, like with arrows 1413 and 1417. In some other embodiments, the top and bottom may have different configurations from each other, such as the top section having the single member, like arrow 1413, while the bottom section having two horizontal members, like in FIG. 14.

The IGU cables of assembly 1400 may be routed within the horizontal and vertical members of the assembly in various manners. This routing may be similar to that described herein above. For example, each IGU cable may extend through one or more of the horizontal members, along the horizontal member and positioned in or restrained by cable retention features 124A-C described above, through a hole in a vertical member, and through the raceway of the vertical member. FIG. 14 illustrates one example routing and positioning of the IGUs cables. Here, for example, cable 1418A of IGU 1402 extends through horizontal member 1414 and along this member 1414's cavity, through a hole in vertical member 1406 and in its raceway upwards, then through another hole in the vertical member 1406 and into the top horizontal member 1411, and through a hole in vertical member 1407, and out the common area 1452. Cable 1418B may also follow the same path as IGU cable. Cables 1418C and 1418D extend into horizontal 1415, through a hole of vertical 1407, in the raceway of vertical 1407 and out the common area 1452. In some implementations these cables 1418A-D may be connected to a single controller (not depicted here).

In some implementations, the horizontal and vertical members are configured to enable and accommodate bending and routing the cables with the optimal bend radius which may be, for instance, ten times the diameter of the cable. In some instances, the cables provided herein may be coaxial cables which may require large bend radiuses as compared to thinner electrical wires.

Although “IGU cables” have been used throughout, these “IGU cables” may be considered representative of an electrical pathway between the IGU and the controller, and this pathway may be comprised of multiple segments of cable electrically connected to the IGU. For example, the IGU may have a cable with a connector and this connector and cable may extend through the intermediate horizontal (e.g., intermediate horizontal 214 in FIG. 2), for instance. An SWC and additional cable and connector may be connected to the IGU cable's connector to create a longer cable. In some instances, another cable may be connected to the SWC and routed directly to the controller.

Further, any IGU cable described herein can also be another cable that can be routed within a framing system with IGUs. For example, a cable routed through a hole in an intermediate horizontal member (e.g., intermediate horizontal member 214) or in a vertical member (e.g., vertical member 206 or 208) could include routing cables for one or more transparent displays, e.g., TOLED, positioned on the IGUs. Examples of transparent displays on IGUs are described in U.S. patent application Ser. No. 17/904,156, filed Aug. 12, 2022, and titled “DATA AND POWER NETWORK OF A FACILITY,” U.S. patent application Ser. No. 16/608,157, filed Oct. 24, 2019, and titled “DISPLAYS FOR TINTABLE WINDOWS,” U.S. patent application Ser. No. 17/083,128, filed Oct. 28, 2020, and titled “BUILDING NETWORK”, U.S. patent application Ser. No. 16/608,159, filed Oct. 24, 2019, and titled “TINTABLE WINDOW SYSTEM COMPUTING PLATFORM USED FOR PERSONAL COMPUTING”, U.S. patent application Ser. No. 17/232,598, filed Apr. 16, 2021, and titled “TANDEM VISION WINDOW AND MEDIA DISPLAY,” PCT Application No. PCT/US2021/052587, filed Sep. 29, 2021, and titled “DISPLAY CONSTRUCT FOR MEDIA PROJECTION AND WIRELESS CHARGING,” PCT Application No. PCT/US2021/052595, filed Sep. 29, 2021, and titled “CONFIGURATION ASSOCIATED WITH MEDIA DISPLAY OF A FACILITY ,” and PCT Application No. PCT/US2021/052597, filed Sep. 29, 2021, and titled “DISPLAY CONSTRUCT AND FRAMING FOR MEDIA PROJECTION,” all of which are incorporated by reference in their entireties for all purposes.

Such a cable could also be for a sensor, such as a sensor suite positioned in the mullion like described in PCT Application No. PCT/US2021/030798, filed on May 5, 2021, and titled “DEVICE ENSEMBLES AND COEXISTENCE MANAGEMENT OF DEVICES”, U.S. patent application Ser. No. 16/447,169, filed Jun. 20, 2019, and titled “SENSING AND COMMUNICATIONS UNIT FOR OPTICALLY SWITCHABLE WINDOW SYSTEMS”, PCT Application No. PCT/US2022/014135, filed Jan. 27, 2022, and titled “MULTI-SENSOR SYNERGY”, PCT Application No. PCT/US2021/015378, filed Jan. 28, 2021, and titled “SENSOR CALIBRATION AND OPERATION”, all of which are incorporated by reference in their entireties for all purposes.

Such a cable or cables could also be related to cameras, movable window actuators, switches, trunk lines, detachable power transfers, or a combination thereof. For instance, one of the IGUs of assembly 100 of FIG. 1, assembly 200 of FIG. 2, assembly 500 of FIG. 5, assembly 700 of FIG. 7, assembly 800 of FIG. 8, assembly 900 of FIG. 9, assembly 1000 of FIG. 10, assembly 1100 of FIG. 11, assembly 1200 of FIGS. 12 and 13, or assembly 1400 of FIG. 14 may be configured to be movable with a movable window actuator and cables for powering the movable window actuator could be routed within the raceways, horizontal member, or both as provided herein in order to provide power to such movable window power actuator. Similarly, a detachable power transfer power contact could have its electrical cables or wires routed through a hole in a horizontal or vertical member and routed through within the raceways, horizontal member, or both as provided herein in order to provide to that contact; the cable may be connected to the controller as described herein.

Additionally, a trunk line and/or drop line from a trunk line may be routed through a raceway and/or horizontal and connect to a controller, for example. Examples of trunk lines and power systems for buildings and IGUs are described in U.S. patent application Ser. No. 17/904,156, filed Aug. 12, 2022, and titled “DATA AND POWER NETWORK OF A FACILITY”, U.S. patent application Ser. No. 16/447,169, filed Jun. 20, 2019, and titled “SENSING AND COMMUNICATIONS UNIT FOR OPTICALLY SWITCHABLE WINDOW SYSTEMS,” both of which are incorporated by reference in their entireties for all purposes.

### Smart Window Controller (SWC)

Some IGUs may include a smart window controller (SWC) having a memory or controller chip with memory such as an electrically erasable programmable read-only memory (EEPROM) chip. The memory can store information about the IGU, such as the lite ID and one or more parameters that may be used to drive the tinting and clearing of one or more optically switchable devices of the IGU. In some cases, an IGU cable may be electrically connected to the SWC, directly or via other cabling and connectors, and the SWC is electrically connected to a controller.

In some instances, the SWC is connected directly to the IGU cable of each IGU and the SWC is positioned in the horizontal member where the IGU cable passes through.

In some implementations, one or more SWCs and the controller may be positioned in one horizontal or vertical member.

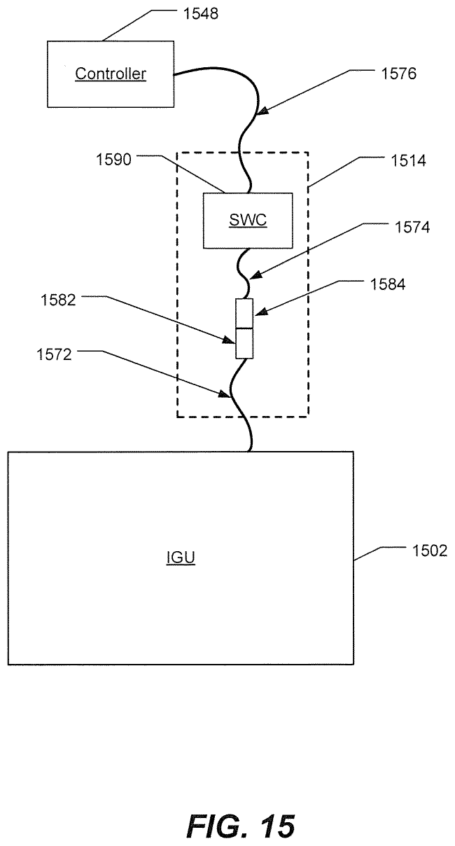

FIG. 15 is a schematic drawing depicting an assembly including a smart window controller (SWC) 1590, an IGU 1502, and a controller 1548, according to embodiments. FIG. 15 illustrates an electrical connection pathway between IGU 1602 and controller 1548 with multiple cables (cable C1 1572, cable C2 1574, and cable C3 1576) and electrical connectors (connector C1 1582, connector C2 1584, and connector C3 1586). In other examples, additional or fewer cables and/or connectors may be employed. For example, cable C3 1576 may include multiple cables electrically connected end to end with each other or cable C3 1576 may include multiple cables in parallel. Each cable may include one or more wires.

In FIG. 15, IGU 1502 includes cable C1 1572 depicted extending from its body and having a connector C1 1582 disposed at a distal end. A proximal end of cable C1 1572 may be electrically connected to one or more bus bars or an electrical connector in electrical communication with the one or more bus bars at IGU 1502. Connector C1 1582 is electrically connected to connector C2 1584 at a distal end of cable C2 1574. Cable C2 1574 is seen extending from SWC 1590. A proximal end of Cable C2 1574 is electrically connected to SWC 1590 and a distal end is electrically connected to connector C2 1584. Cable C3 1576 is seen extending from the SWC 1590 to controller 1548. A proximal end of cable C3 1576 is electrically connected to SWC 1590 and a distal end is electrically connected to controller 1548. In this illustrated example, IGU 1502 is part of an assembly including another IGU and a horizontal member (e.g., intermediate horizontal). One or more of the electrical connectors and cables may be positioned inside the horizontal member as represented, for example, by dashed box 1514.

In some instances, an “IGU cable” provided herein, such as IGU cables 318A, 318B in FIG. 3, IGU cables 418A, 418B in FIG. 4, IGU cables 618A, 618B in FIG. 6, IGU cable 818 in FIG. 8, IGU cables 1018A, 1018B in FIG. 10, IGU cables 1118A, 1118B in FIG. 11, IGU cables 1218A and 1218B in FIGS. 12 and 13, IGU cables 1418A and 1418B in FIG. 14, etc., may include one or more of components described with reference to FIG. 15 such as, for example, (i) cable C1 1572 and connector C1 1582, (ii) cable C1 1572, connector C1 1582, cable C2 1574, and SWC 1590, or (iii) cable C1 1572, connector C1 1582, cable C2 1574, connector C2 1584, SWC 1590, and cable C3 1576. Further, some of these components may be positioned inside an intermediate horizontal of an assembly, as represented, for example, by dashed box 1514 in FIG. 15. This may include a portion of cable C1 1572, the connector C1 1582, connector C2 1584, SWC 1590, and a portion of cable C3 1576. Another portion of cable C3 1576 may extend through a vertical member of the assembly 1500 in FIG. 15. Assembly 1500 may be a unitized assembly or an assembly in a stick build configuration.

In some instances, an IGU cable that extends directly from the IGU may have one or more wires that are connected to another wire connected to the SWC, and the SWC may be connected to one or more other cables. As mentioned above, the SWC may include a chip with memory, such as an electrically erasable programmable read-only memory (EEPROM) chip, that may store information about the IGU, such as the lite ID and one or more parameters used to drive the tinting and clearing of the IGU.

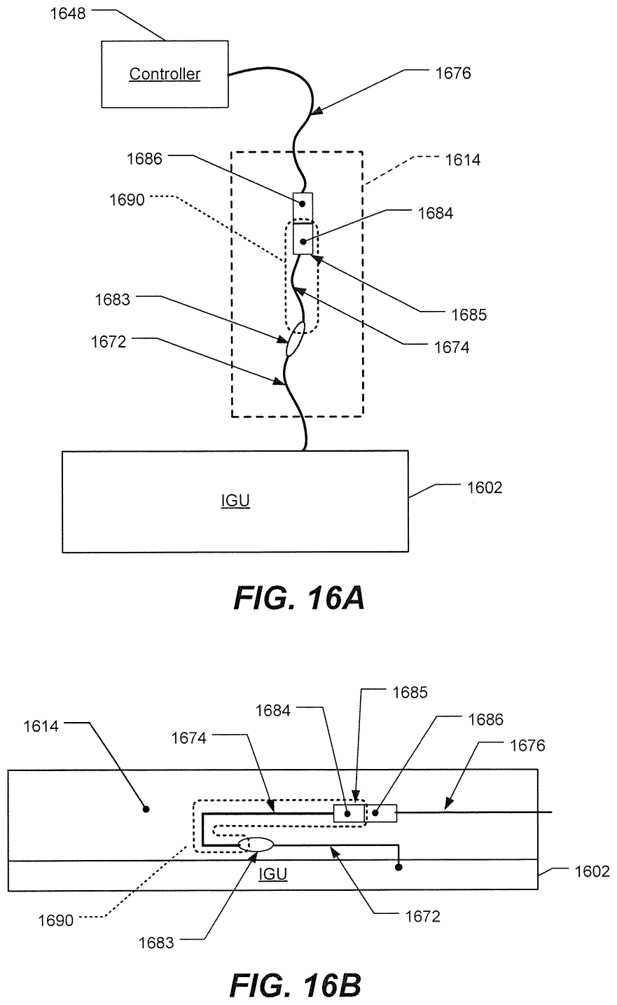

FIG. 16A is a schematic drawing depicting an example of a wire and cable configuration of an assembly including an SWC 1690, according to embodiments. FIG. 16B depicts a plan view of components of the assembly in FIG. 16A. The assembly includes components of an assembly having an IGU 1602 and an intermediate horizontal member, 1614 (denoted by dashed line box). The assembly may be a unitized assembly or an assembly in a stick build configuration.

In FIGS. 16A and 16B, an IGU cable 1672 extends from IGU 1602. IGU cable 1672 may include two or more wires such as, e.g., a red wire and a black wire, that may be positive and negative terminals, respectively, for IGU 1602. IGU cable 1672 may be electrically connected to one or more bus bars of IGU 1602 and extend through one or more seals of IGU 1602. In some implementations, an end of IGU cable 1672 may have one or more exposed portions of a wire, such as a metal portion without insulation. In addition, another cable 1676 extends from SWC 1690 to a controller 1648. One end of cable 1676 is electrically connected to SWC 1690 and another end is electrically connected to controller 1648.

Also shown is SWC 1690 with components encompassed by the dotted line. SWC 1690 includes an SWC body 1685 and an SWC cable 1674. SWC body 1685 includes a SWC connector 1684. IGU cable 1672 may be physically and electrically connected to SWC cable 1674, such as by splicing cable 1672 and SWC cable 1674 together at a splice point or junction 1683. In some implementations, a bare, exposed wire of IGU cable 1672 may be physically and electrically connected to a bare, exposed wire of SWC cable 1674 at splice point or junction 1682. In some other implementations, similar to FIG. 15, IGU cable 1672 may have one or more connectors (e.g., connector 1582 in FIG. 15) and SWC cable 1676 may have one or more connectors (e.g., connector 1584 in FIG. 15) configured to interface and connect with each other to physically and electrically connect these cables.

In some embodiments, an SWC may include a connector for connecting with another cable that may be electrically connected (e.g., via an electrical connector) to a controller. This other cable maybe interposed between the SWC and the controller in some cases. In certain implementations, the SWC body may include a connector for connecting with a connector of another cable, such as a connector at an end of the SWC cable that extends from the SWC body to the controller. For example, in FIGS. 16A and 16B, SWC 1690 includes SWC body 1685 that includes a SWC connector 1685 for connecting to connector 1686 at an end of cable 1676 where the other end of cable 1676 may be electrically connected to controller 1648.

In some embodiments, an IGU cable extending from an IGU of an assembly may extend into an intermediate horizontal member. In addition or alternatively, the electrical connection between the SWC and a cable extending from the controller may be made in the intermediate horizontal member. For example, in FIGS. 16A and 16B, IGU cable 1672 extends into intermediate horizontal member 1614 where IGU cable 1672 is physically and electrically connected to SWC 1690, including to SWC cable 1674. In addition, electrical connector 1686, which establishes electrically connection between SWC 1690 and cable 1676 extending from controller 1648, is within intermediate horizontal member 1614.

As shown in FIGS. 16A and 16B, IGU cable 1672 may be routed into horizontal member 1614, connected with SWC cable 1674 at connection point 1683 in horizontal member 1614. In one implementation, SWC 1672 may also be connected with another cable 1682 in the horizontal member 1614, and that other cable 1682 may be routed through the horizontal member 1614, into a vertical member of the assembly, and electrically connected to controller 1648 (not shown in FIG. 16B) as described herein.

The configurations of FIGS. 16A and 16B may differ from other IGUs of other configurations which may have the connection point between the SWC and the IGU cable, e.g., connection point 1678 in FIGS. 16A and 16B, may be within the IGU seal in some implementations. The implementations in FIGS. 16A and 16B may provide significant advantages, such as, e.g., the ability to relocate and reposition a connection point (e.g., connection point 1683) of an SWC and an IGU cable, flexibility in routing the IGU cable extending from the IGU through a hole in the horizontal member (e.g., horizontal member 1614, horizontal member 214, horizontal member 314, horizontal member 414, horizontal member 614, horizontal member 714, horizontal member 724, horizontal member 814, horizontal member 1014, horizontal member 1114, horizontal member 1214, horizontal member 1414, and horizontal member 1514, and horizontal member 1614), ease of placing the SWC body within the framing such as within the horizontal member or vertical member, etc.

In FIGS. 16A and 16B, the assembly includes cables (e.g., cable 1672, SWC cable 1674, and cable 1676) and electrical connectors (e.g., connector 1684 and connector 1686). In other examples, additional or fewer cables and/or connectors may be employed. One or more of the electrical connectors and cables may be positioned inside the horizontal member of the assembly as represented, for example, by dashed box 1614.

### II. Methods of Fabrication

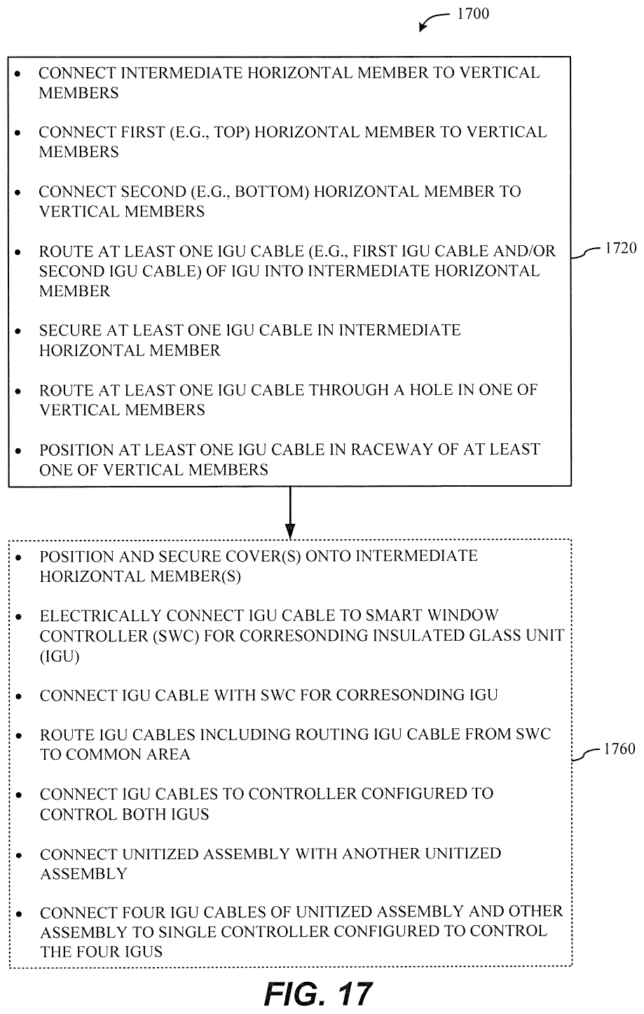

The assemblies provided herein may be manufactured in various manners and techniques. FIG. 17 depicts a flowchart including operations of a manufacturing technique or method of fabrication of an assembly having two or more IGUs, according to various implementations. The method of fabrication can be employed to manufacture, for example, various assembles provided herein such (A) assemblies having two IGUs such as such as assembly 100 in FIG. 1A, assembly 200 in FIG. 2, assembly 300 in FIG. 3, assembly 400 in FIGS. 4 and 5, assembly 600 in FIG. 6, assembly 700 in FIG. 7A, assembly 701 in FIG. 7B, assembly 800 in FIG. 8, assembly 900 in FIG. 9, assembly 1000 in FIG. 10, assembly 1100 in FIG. 11, and/or assembly 1200 in FIGS. 12 and 13 or (B) assemblies having four IGUs such as assembly 101 in FIG. 1B and/or assembly 1400 in FIG. 14. The manufacturing technique or method fabrication may include at least two or more of the steps in block 1720, which may be performed in different sequences and order. For example, an intermediate horizontal member may be connected to vertical members. In FIG. 2, for instance, intermediate horizontal member 214 may be connected to vertical members 206 and 208. As another instance, in FIG. 14, intermediate horizontal members 1414 and 1415 may be connected to vertical members 1407, 1406, and 1408. As another example, a first (e.g., top) horizontal member may be connected to vertical members. In FIG. 2, for instance, first horizontal member 211 may be connected to vertical members 106 and 108. As another instance, in FIG. 14, horizontal member 1411 may be connected to vertical members 1407, 1406, and 1408. As another example, a second (e.g., bottom) horizontal member may be connected to vertical members. In FIG. 2, for instance, first horizontal member 216 may be connected to vertical members 106 and 108. As another instance, in FIG. 14, horizontal members 1416 and 1419 may be connected to vertical members 1407, 1406, and 1408. As another example, one or more IGU cables of an IGU may be routed into an intermediate horizontal member. In FIG. 12, for instance, IGU cable 1218A and/or IGU cable 1218B may be routed into intermediate horizontal member 1214. As another instance, in FIG. 14, one or more of IGU cables 1418A, 1418B, 1418C, or 1418D may be routed into one or both of intermediate horizontal members 1414 and 1415. As another example, one or more IGU cables of an IGU may be secured in an intermediate horizontal member. In FIG. 12, for instance, IGU cable 1218A and/or IGU cable 1218B may be secured in intermediate horizontal member 1214. As another instance, in FIG. 14, one or more of IGU cables 1418A, 1418B, 1418C, or 1418D may be secured in one or both of intermediate horizontal members 1414 and 1415. As another example, one or more IGU cables of an IGU may be routed through a hole in one of the vertical members. In FIG. 12, for instance, IGU cable 1218A and/or IGU cable 1218B may be routed through a hole in one of the vertical members 1206 and 1208. As another instance, in FIG. 14, one or more of IGU cables 1418A, 1418B, 1418C, or 1418D may be routed through a hole in one of the vertical members 1407, 1406, and 1408. As another example, one or more IGU cables of an IGU may be positioned in a raceway of one of the vertical members. In FIG. 12, for instance, IGU cable 1218A and/or IGU cable 1218B may be positioned in a raceway of one of the vertical members 1206 or 1208. As another instance, in FIG. 14, one or more of IGU cables 1418A, 1418B, 1418C, or 1418D may be positioned in a raceway of one of the vertical members 1407, 1406, or 1408.

Returning to FIG. 17, optionally (denoted by dashed line) the manufacturing technique or method of fabrication may include one or more of the steps in block 1760, which may be performed in different sequences and order. For example, a cover (e.g., a removable cover) may be positioned and secured onto an intermediate horizontal member. In FIG. 4, for instance, removable cover 430 may be positioned and secured onto intermediate horizontal member 214. As another instance, in FIG. 14, removable covers (e.g., removable covers 430 in FIG. 4) may be positioned and secured onto intermediate horizontal members 1414 and 1415. As another example, one or more IGU cables (e.g., 218A and 218B) may be connected with an SWC for the corresponding IGU (e.g., 202 and 204). In FIG. 15, for instance, IGU cable 1572 of IGU 1502 may be connected to SWC 1590 for that IGU 1502 via connectors 1572 and 1582. As another example, one or more IGU cables may be routed from the SWC to a common area (e.g., common area 652 in FIG. 6, common area 1252 in FIGS. 12 and 13, and common area 1452 in FIG. 14). As another example, one or more IGU cables may be connected to a controller configured to control the IGUs in the assembly. In FIG. 11, for instance, IGU cables 1118A and 1118B may be electrically connected to controller 1148 to control IGUs 1102 and 1104. As another instance, in FIG. 12, IGU cables 1218A and 1218B may be connected to controller 1248 to control IGUs 1202 and 1204. In yet another instance, in FIG. 15, IGU cable 1572 may be electrically connected to controller 1548 via cables and connectors. As another instance, in FIG. 15, IGU cables 1518A and 1518B may be connected to controller 1548 to control IGUs 1502 and 1504. As another instance, in FIGS. 16A and 16B, IGU cables 1618A and 1618B may be connected to controller 1648 to control IGUs 1602 and 1604. As another example, an assembly may be connected to one or more additional single unit assemblies to form a combined assembly. For instance, assembly 200 having two IGUs in FIG. 2 may be connected to another assembly 200 having two IGUs. In one aspect, the IGU cables of the combined assembly may be connected to a single controller configured to control all the IGUs. For instance, assembly 200 having two IGUs in FIG. 2 may be connected to another assembly 200 having two IGUS and the four IGU cables may be connected to a single controller configured to control the four IGUs.

Although the foregoing embodiments have been described in some detail to facilitate understanding, the described embodiments are to be considered illustrative and not limiting. It will be apparent to one of ordinary skill in the art that certain changes and modifications can be practiced within the scope of the appended claims.

Modifications, additions, or omissions may be made to any of the above-described implementations without departing from the scope of the disclosure. Any of the implementations described above may include more, fewer, or other features without departing from the scope of the disclosure. Additionally, the steps of described features may be performed in any suitable order without departing from the scope of the disclosure. Also, one or more features from any implementation may be combined with one or more features of any other implementation without departing from the scope of the disclosure. The components of any implementation may be integrated or separated according to particular needs without departing from the scope of the disclosure.

Any of the software components or functions described in this application, may be implemented as software code using any suitable computer language and/or computational software such as, for example, Java, C, C #, C ++ or Python, LabVIEW, Mathematica, or other suitable language/computational software, including low level code, including code written for field programmable gate arrays, for example in VHDL. The code may include software libraries for functions like data acquisition and control, motion control, image acquisition and display, etc. Some or all of the code may also run on a personal computer, single board computer, embedded controller, microcontroller, digital signal processor, field programmable gate array and/or any combination thereof or any similar computation device and/or logic device(s). The software code may be stored as a series of instructions, or commands on a CRM such as a random access memory (RAM) , a read only memory (ROM) , a magnetic medium such as a hard-drive or a floppy disk, or an optical medium such as a CD-ROM, or solid stage storage such as a solid state hard drive or removable flash memory device or any suitable storage device. Any such CRM may reside on, or within, a single computational apparatus, and may be present on or within different computational apparatuses within a system or network. Although the foregoing disclosed implementations have been described in some detail to facilitate understanding, the described implementations are to be considered illustrative and not limiting. It will be apparent to one of ordinary skill in the art that certain changes and modifications can be practiced within the scope of the appended claims.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g., “such as”) provided with respect to certain implementations herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or implementations of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

What is claimed is:

1. An assembly comprising:
first and second insulated glass units (IGUs);
a frame comprising an intermediate horizontal member and a first vertical member, wherein the intermediate horizontal member is interposed between the first and second IGUs; and
one or more IGU cables in electrical communication with the first and second IGUs;
wherein the frame is configured to pass the one or more IGU cables from the first and second IGUs into the intermediate horizontal member and through the first vertical member.

2. The assembly of claim 1, wherein the frame is configured to pass the one or more IGU cables from the first vertical member to outside the assembly.

3. The assembly of claim 1, wherein the frame is configured to pass the one or more IGU cables from the first vertical member to outside the assembly to electrically connect to a controller.

4. The assembly of claim 1, wherein the frame further comprises a top horizontal member, wherein the one or more IGU cables are configured to pass from the first vertical member into the top horizontal member.

5. The assembly of claim 1, further comprising a controller within the frame, the controller in electrical communication with the one or more IGU cables.

6. The assembly of claim 1, further comprising a controller within a body of the intermediate horizontal member, the controller in electrical communication with the one or more IGU cables.

7. The assembly of claim 5, further comprising a cable in electrical communication with the controller and in electrical communication with a network or infrastructure of a building.

8. The assembly of claim 5, wherein the controller is a smart window controller having a memory configured to store information about the first IGU and/or the second IGU.

9. The assembly of claim 1, wherein the intermediate horizontal member comprises a port or a hole configured to receive at least one of the one or more IGU cables.

10. The assembly of claim 9, further comprising a protective material on at least one edge of the port or hole.

11. The assembly of claim 9, wherein the first vertical member comprises a port or a hole configured to receive the at least one IGU cable from the intermediate horizontal member.

12. The assembly of claim 1, wherein the one or more IGU cables are in electrical communication with bus bars of optically switchable devices of the first and second IGUs.

13. The assembly of claim 1, wherein the frame further comprises a second vertical member, a top horizontal member, and a bottom horizontal member, wherein the intermediate horizontal member, the top horizontal member, and the bottom horizontal member span between the first and second vertical members.

14. An assembly comprising:
a smart window controller (SWC) comprising a memory configured to store information about an insulated glass unit;
a SWC cable in electrical communication with the smart window controller;
an IGU cable in electrical communication with an insulated glass unit and with the SWC cable; and
a third cable in electrical communication with the smart window controller and a second controller.

15. The assembly of claim 14, further comprising a junction or splice point configured to electrically connect the IGU cable with the SWC cable.

16. The assembly of claim 14, further comprising a first connector at an end of the IGU cable and a second connector at an end of the SWC cable, the second connector configured to connect to the first connector.

17. A method of fabricating an assembly comprising first and second insulated glass units and a frame, the frame comprising a vertical member and an intermediate horizontal member interposed between the first and second insulated glass units, the method comprising:
routing a first IGU cable from the first insulated glass unit into the intermediate horizontal member; and
routing the first IGU cable through a hole in the vertical member and passing the first IGU cable through the vertical member.

18. The method of claim 17, further comprising electrically connecting another cable in electrical communication with the smart window controller at a proximal end and in electrical communication with another controller at a distal end.
